(19) United States
(12) Patent Application Publication
(10) Pub. No.: US 2004/0215966 A1
(43) Pub. Date: Oct. 28, 2004

(54) Bending USB token

(75) Inventor: Laszlo Elteto, Irvine, CA (US)

Correspondence Address: GATES & COOPER LLP, HOWARD HUGHES CENTER, 6701 CENTER DRIVE WEST, SUITE 1050, LOS ANGELES, CA, 90045, US

(73) Assignees: RAINBOW TECHNOLOGIES, INC.; RAINBOW TECHNOLOGIES B.V.

(21) Appl. No.: 10/827,086

(22) Filed: Apr. 19, 2004

Related U.S. Application Data
(60) Provisional application No. 60/466,096, filed on Apr. 28, 2003.

(51) Int. Cl. G06F 3/00

(52) U.S. Cl. 713/182

(57) ABSTRACT

A bending token for providing conditional access to data stored therein is disclosed. The token comprises a first member, for insertion into a USB-compliant host computer female connector along a first longitudinal axis, USB-compliant host computer female connector having a plurality of host conductive surfaces; a second member, disposed along a second longitudinal axis, the second member having a processor providing conditional access to data stored in a memory; a flexible conductor, electrically coupling the processor and the plurality of host conductive surfaces when the first member is inserted into the USB-compliant host computer female connector; and a bendable member, coupled to the first member and the second member, the bendable member permitting the second longitudinal axis rotated away from the first longitudinal axis.

### CROSS-REFERENCE TO RELATED APPLICATIONS

This application claims benefit of U.S. Provisional Patent Application No. 60/466,096, entitled “BENDING USB TOKEN,” filed Apr. 28, 2003, by Laszlo Elteto, which application is hereby incorporated by reference herein.

This application is also related to the following co-pending and commonly assigned patent application(s), all of which applications are incorporated by reference herein:

application Ser. No. 09/449,159, entitled “USB-COMPLIANT PERSONAL KEY WITH INTEGRAL INPUT AND OUTPUT DEVICES” by Shawn D. Abbott, Bahram Afghani, Mehdi Sotoodeh, Norman L. Denton III, and Calvin W. Long, filed Nov. 24, 1999, which is a continuation-in-part of U.S. patent application Ser. No. 09/281,017, filed Mar. 30, 1999 by Shawn D. Abbott, Bahram Afghani, Allan D. Anderson, Patrick N. Godding, Maarten G. Punt, and Mehdi Sotoodeh, and entitled “USB-COMPLIANT PERSONAL KEY,” now, U.S. Pat. No. 6,671,808, issued Dec. 30, 2003, which claims benefit of U.S. Provisional Patent Application No. 60/116,006, filed Jan. 15, 1999 by Shawn D. Abbott, Barham Afghani, Allan D. Anderson, Patrick N. Godding, Maarten G. Punt, and Mehdi Sotoodeh, and entitled “USB-COMPLIANT PERSONAL KEY,” both of which applications are hereby incorporated by reference herein.

### BACKGROUND OF THE INVENTION

Description of the Related Art

As described in the above patent applications, one way of authenticating the user of a security token is by the use of biometric sensors. FIG. 1 is a diagram presenting an illustration of a token 100 having a male USB connector 106, communicatively coupled to a female Universal Serial Bus (USB) connector 108 in a host computer 110. The token 100 includes a biometric sensor 112 such as a fingerprint sensor disposed on the housing 102. The fingerprint sensor 112 is communicatively coupled to a processor 122 via connection 124. The processor 122 is typically disposed on a printed circuit board (PCB) 104 within housing 102, and using instructions and data stored in a memory also within the housing 102, performs token 100 operations. Typically, the PCB 104 comprises a plurality of circuit traces, and is oriented along the longitudinal axis 118 of the token 100. The PCB circuit traces are communicatively coupled to token connectors or pins 118 on the male USB connector 106. When the token 100 is inserted into the female USB connector 108 of the host computer 110, the token connectors 118 are slidingly urged against corresponding host computer connectors or pins 116 in the female USB connector 108, thus providing communication between the processor 122 and a processor in the host computer 110.

One of the problems with the use of tokens with biometric sensors is that when connected to the host computer 110, the token 100 is both rigid and cantilevered out from the computer 100 in a way that renders either the token 100 or the interface connector 108, 106 susceptible to damage. The inclusion of a biometric sensor 112 exacerbates this problem because the user is required to place his or her finger 114 on the biometric sensor 112. Although the user need not press hard for the biometric sensor 112 to take a reading, it is expected that many users will do so nonetheless. Also, although the token should be held in the hand with the fingers on the top and bottom sides (i.e. using a finger 114 and a thumb 126 as shown in FIG. 2), it is expected that many users will fail to do so (as shown in FIG. 1), and apply pressure to the top portion of the token alone. As a result, the physical I/O interfaces 108, 106 between the token and the computer can be damaged. Such damage can include the token's male connector 106, the computer's female connector 108, or both.

What is needed is an apparatus and method that permits the secure, integrated connection between the token and the host computer that is also resistant to damage. The present invention satisfies that need.

### SUMMARY OF THE INVENTION

To address the requirements described above, the present invention discloses a bending token and a method for using same. In one embodiment, the bending token comprises a first member, for insertion into a USB-compliant host computer female connector along a first longitudinal axis, USB-compliant host computer female connector having a plurality of host conductive surfaces; a second member, disposed along a second longitudinal axis, the second member having a processor providing conditional access to data stored in a memory; a flexible conductor, electrically coupling the processor and the plurality of host conductive surfaces when the first member is inserted into the USB-compliant host computer female connector; and a bendable member, coupled to the first member and the second member, the bendable member permitting the second longitudinal axis rotated away from the first longitudinal axis.

The invention is also embodied in an apparatus for flexibly coupling a security token to a processor. The apparatus comprises a first member, having a male USB-compliant connector disposed along a first longitudinal axis and a plurality of conductive surfaces providing electrical communication with the host computer; a second member, having a female USB-compliant connector disposed along a second longitudinal axis, the female USB connector having a second plurality of conductive surfaces electrically coupled to the first plurality of conductive surfaces via a flexible conductor; and a joint, coupled to the first member and the second member, the joint permitting the second member to be rotated about the joint so that the second longitudinal axis is non-colinear with the first longitudinal axis.

The invention can also be described by a method of flexibly coupling a token to a host cmputer, comprising the steps of inserting a first member of the token into a USB-compliant host computer connector along a first longitudinal axis, and bending the inserted token so that a longitudinal axis of a second member of the token is non-colinear with the first longitudinal axis.

### BRIEF DESCRIPTION OF THE DRAWINGS

Referring now to the drawings in which like reference numbers represent corresponding parts throughout:

FIG. 1 is a block diagram showing a cross-section of a conventional token-host computer interface;

FIG. 2 is a diagram showing a preferred method of using a biometric sensor on a token; and

FIGS. 3A and 3B are diagrams showing one embodiment of the present invention;

FIG. 4 is a diagram showing additional details of the embodiment shown in FIGS. 3A and 3B;

FIG. 5 is a diagram presenting an embodiment wherein the flexible wiring and conducting surfaces are embodied in a flex circuit; and

FIG. 6 is a diagram showing a further embodiment of the present invention.

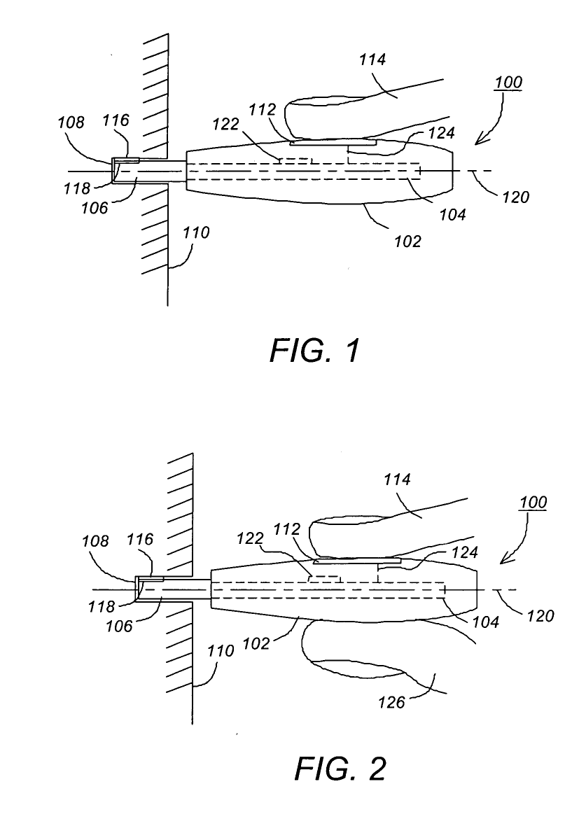

### DETAILED DESCRIPTION OF PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

To prevent damage to the security token or the host computer interface, the present invention includes a means for permitting bending about at least one axis.

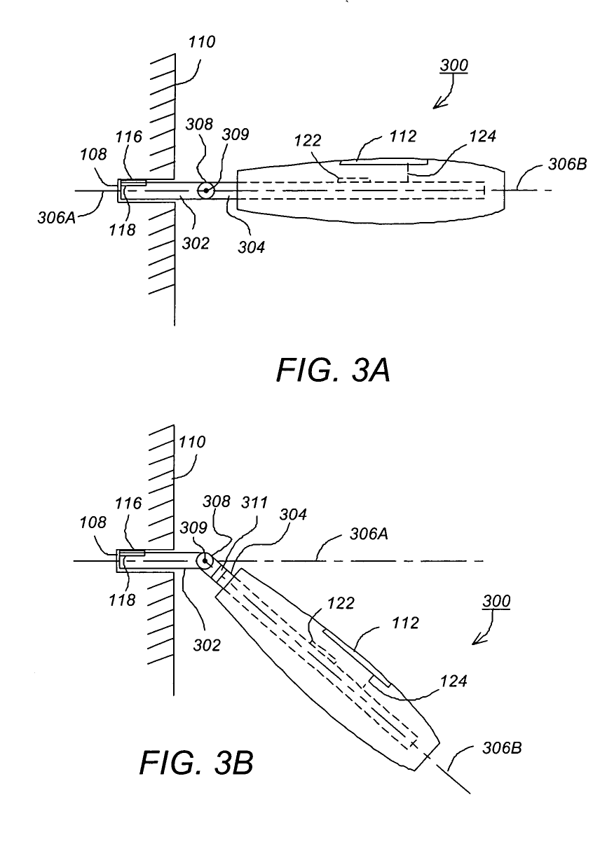

FIG. 3A is a diagram showing one embodiment of the bendable token 300 in a first (extended) position. In this embodiment, the bendable token 300 includes a first member 302 for insertion into the female USB connector 108 along a first axis 306A, and a second member 304 that is disposed along a longitudinal axis 306B of the token body. The first member 302 is coupled to the second member 304 by a joint 308 such as a hinge or a ball joint. The joint 308 permits the first member 302 (in the illustrated embodiment, a male USB connector) to be inserted into the female USB connector 108 in the host computer 110 along a first axis 306A, while the main body of the bendable token 300 (e.g. the housing 102 and the components disposed therein) can be rotated so that it is longitudinally oriented along a second axis 306B that is not colinear with the first axis 306A, as shown in FIG. 3B.

In one embodiment, the joint 308 is a hinge that only allows rotation about a hinge axis 309 and thus only in a single (e.g. vertical) plane, but the joint 308 may be designed to allow bending in the horizontal plane, or both the horizontal and vertical planes. This may be implemented with a ball joint or a joint implemented by a multidirectional flexible member such as a length of rubber or other flexible material. Bending in multiple orthogonal planes can also be accomplished with a joint similar to a universal joint. Alternatively, the joint 308 can include a feature which permits motion in a single plane (such as a hinge) and a rotatable joint feature 311 which permits rotation of the plane of motion provided by the hinge (similar to structures that are used to allow rotation of telephone receiver cords) thus effectively permitting the second axis 306B to be placed in any desired orientation relative to the first axis 306A.

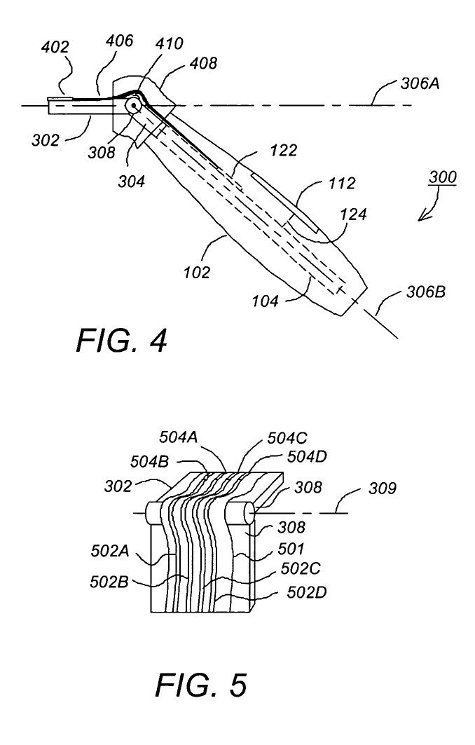

FIG. 4 is a diagram presenting a cross-section of the bendable token 300. In this embodiment, the first member 302 is a male USB connector that is insertable into the USB compliant host computer (female) connector 108. The second member 304 couples to the PCB 104 or the token housing 102. The male USB connector includes conducting pins 402 which are communicatively coupled to a processor on the PCB 104 via flexible wiring 406, permitting motion by the hinge 308.

FIG. 5 is diagram presenting an embodiment wherein the flexible wiring 406 and the conducting surfaces 402 are implemented by a flex circuit 501, and the conducting pins 402 on the male USB connector are exposed circuit trace portions 504A-504D. In another embodiment, the conducting surfaces 402 are pins, which can be simply connected to a flex circuit or flexible wires to facilitate connection with the PCB 104. In either case, a flexible protective member 408, preferably made from a rubber-like material can be used to protect the flexible wiring 406. The flexible wiring 406 can be disposed in a location relative to the joint 308 to prevent damage thereto when the bendable token 300 is manipulated. Further, a protective member 410 can be inserted between the flexible wiring 406 and the joint 308 to prevent such damage.

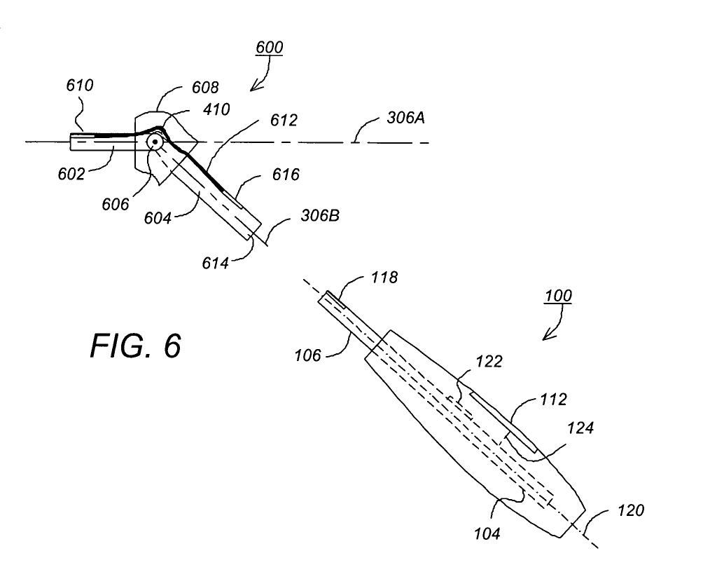

FIG. 6 is a diagram illustrating another embodiment of the present invention. In this embodiment, the invention comprises a bendable USB connector extension 600. The USB connector extension 600 includes a first member 602, a second member 604, and a joint 606 analogous to the joints described above coupling the first member 602 and the second member 604 together. The joint 606 permits the longitudinal axis 306B of the second member 604 to be rotated about the joint 606. In this embodiment, the first member 602 comprises a male USB connector and the second member 604 comprises a female USB connector having a cavity 614 configured to accept the male USB connector 106 of a token 100. The male USB token connector 602 comprises male adapter connectors 610, which physically interface with and electrically contact the associated connectors 116 in the female USB connector 108. Flexible wiring 612 communicatively couples the male adapter connectors 610 to female adapter connectors 616, in a manner analogous to that which is described above.

The cavity 614 is configured to accept the male USB connector 106 of the token 100. The female adapter connectors 616 are disposed and configured to electrically contact the token connectors 118 when the USB connector 106 of the non-bendable token 100 is accepted within the cavity 614, thus providing electrical connection between the token 100 and the host computer 110.

This embodiment is useful to prevent damage to a legacy (rigid) token 100 that does not incorporate the bending features described above in FIGS. 3-4. However, since the connector extension 600 is removable, the user may still couple the non-bendable token 100 to the host computer 110, exposing the token 100 or the host computer connector 108 to the possibility of damage.

While the bendable token 300 and the bendable connector 600 both prevent damage to connector interface in the host computer 110 and the tokens themselves, they are also useful in applications where space is of value. For example, the female USB connector 108 on most laptop computers is on a rear-facing surface. When used in passenger airplanes, the space behind the laptop computer is at a premium, and often does not permit the insertion of a token. The bendable token 300 and the bendable connector 600 permit the use of such devices where space is a premium, even those without biometric sensors.

### CONCLUSION

This concludes the description of the preferred embodiments of the present invention. The foregoing description of the preferred embodiment of the invention has been presented for the purposes of illustration and description. It is not intended to be exhaustive or to limit the invention to the precise form disclosed. Many modifications and variations are possible in light of the above teaching. For example, while the foregoing has been described in a particular embodiment suitable for interconnecting components complying with the USB specification, the present invention can be used with different connector designs. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A flexible token, comprising:
a first member, for insertion into a USB-compliant host computer female connector along a first longitudinal axis, USB-compliant host computer female connector having a plurality of host conductive surfaces;
a second member, disposed along a second longitudinal axis, the second member having a processor providing conditional access to data stored in a memory;
a flexible conductor, electrically coupling the processor and the plurality of host conductive surfaces when the first member is inserted into the USB-compliant host computer female connector; and
a bendable member, coupled to the first member and the second member, the bendable member permitting the second longitudinal axis rotated away from the first longitudinal axis.

2. The apparatus of claim 1, wherein the bendable member comprises a joint permitting the second member to be rotated about the joint so that the second longitudinal axis is non-colinear with the first longitudinal axis.

3. The apparatus of claim 2, wherein the joint is a ball joint.

4. The apparatus of claim 1, wherein the bendable member comprises a hinge.

5. The apparatus of claim 4, wherein:
the hinge is bendable in a single plane; and
the bendable member further comprises a rotatable member permitting rotation of the plane.

6. The apparatus of claim 5, wherein the bendable member comprises a gooseneck.

7. The apparatus of claim 1, wherein the flexible conductor comprises:
a plurality of token conductive surfaces; and
flexible wires communicatively coupled to the plurality of token conductive surfaces and the processor.

8. The apparatus of claim 1, wherein the flexible conductor comprises:
a plurality of token conductive surfaces;
a flex circuit, having a plurality of conductive traces coupled to the plurality of token conductive surfaces and the processor.

9. The apparatus of claim 1, wherein the flexible conductor comprises a flex circuit, having:
a plurality of conductive traces communicatively coupled to the processor, the plurality of conductive traces including exposed portions presenting conductive surfaces contacting the host conductive surfaces when the first member is inserted into the USB host computer female connector.

10. The apparatus of claim 1, wherein:
the token comprises a fingerprint sensor disposed on a surface of the token; and
the bendable member is bendable in a plane perpendicular to the surface of the token.

11. An apparatus for flexibly coupling a security token having a processor to a host computer, comprising:
a first member, having a male USB-compliant connector disposed along a first longitudinal axis and a plurality of conductive surfaces providing electrical communication with the host computer;
a second member, having a female USB-compliant connector disposed along a second longitudinal axis, the female USB connector having a second plurality of conductive surfaces electrically coupled to the first plurality of conductive surfaces via a flexible conductor; and
a joint, coupled to the first member and the second member, the joint permitting the second member to be rotated about the joint so that the second longitudinal axis is non-colinear with the first longitudinal axis.

12. The apparatus of claim 11, wherein the flexible wiring comprises a flex circuit.

13. The apparatus of claim 12, wherein the flex circuit comprises a plurality of conductive traces having first exposed portions forming the first plurality of conductive surfaces and second exposed portions forming the second plurality of conductive surfaces.

14. The apparatus of claim 13, wherein the joint comprises a ball joint.

15. The apparatus of claim 13, wherein the joint comprises a hinge.

16. An apparatus for coupling a security token having a processor to a host computer, comprising:
a first member, for insertion into a USB-compliant host computer connector along a first longitudinal axis, the first member having a plurality of conductive surfaces providing electrical communication with the host computer;
a second member disposed along a second longitudinal axis;
a joint, coupled to the first member and the second member, the joint permitting the second member to be rotated about the joint so that the second longitudinal axis is not colinear with the first longitudinal axis; and
flexible wiring, electrically coupled to the plurality of conductive surfaces, for providing communications between the host processor and the computer.

17. An apparatus for coupling a security token having a processor to a host computer, comprising:
a first member, having a male USB-compliant connector disposed along a first longitudinal axis and a plurality of conductive surfaces providing electrical communication with the host computer;
a second member, having a female USB-compliant connector disposed along a second longitudinal axis, the female USB connector having a second plurality of conductive surfaces electrically coupled to the first plurality of conductive surfaces via flexible wiring; and
a joint, coupled to the first member and the second member, the joint permitting the second member to be rotated about the joint so that the second longitudinal axis is not colinear with the first longitudinal axis.

18. A method of flexibly coupling a token to a host computer, the token comprising a processor providing conditional access to data stored in a memory communicatively coupled to the processor, the method comprising the steps of:
inserting a first member of the token into a USB-compliant host computer connector along a first longitudinal axis; and
bending the inserted token so that a longitudinal axis of a second member of the token is non-colinear with the first longitudinal axis.

19. The method of claim 18, wherein the second member comprises the processor.
